(19) United States
(12) Patent Application Publication
(10) Pub. No.: US 2014/0053252 A1
(43) Pub. Date: Feb. 20, 2014

(54) System and Method for Secure Document Distribution

(71) Applicant: Opera Solutions, LLC, Jersey City, NJ (US)

(72) Inventor: Herbert Kelsey, Wall Township, NJ (US)

(73) Assignee: Opera Solutions, LLC, Jersey City, NJ (US)

(21) Appl. No.: 13/966,720

(22) Filed: Aug. 14, 2013

Related U.S. Application Data
(60) Provisional application No. 61/683,004, filed on Aug. 14, 2012.

(51) Int. Cl. H04L 29/06

(52) U.S. Cl. CPC H04L 63/06
USPC 726/6

(57) ABSTRACT

A system and method for secure document distribution is provided. The system includes a computer system and a secure document distribution engine. The system includes a two-factor authentication system that includes a password and a hardware component. Documents can be accessed from a network (e.g., the Internet, a cloud computing resource, etc.), via a link as an e-mail attachment, or as a stored file. Redistribution of documents by malicious authorized users is not possible without attribution due to the view-only nature of the system in combination with other measures that include event logging and document watermarking. Access can be revoked or blocked in real time, regardless of how the files were distributed or where they reside.

### CROSS-REFERENCE TO RELATED APPLICATION

This application claims priority to U.S. Provisional Patent Application No. 61/683,004 filed on Aug. 14, 2012, which is incorporated herein in its entirety by reference and made a part hereof.

### BACKGROUND OF THE INVENTION

1. Field of the Invention

The present invention relates generally to systems for providing digital security. More specifically, the present invention relates to a system and method for secure document distribution.

2. Related Art

The sheer breadth and depth of diverse information on the Internet is an indispensable resource for business and government. The value of such information increases as it is culled, cooperatively used, and acted upon. Moreover, it is increasingly common to store and back-up information in a public cloud via the Internet, where such information is accessible to mobile and dynamic users, or teams of users, by a variety of end-user computing environments. The sharing of information is often essential to effectively complete a job or a task. However, the very act of sharing information puts such information at risk because of the ease with which a digital copy can be made and distributed to others.

There are various known methods for protecting digital content. For example, one method involves merely marking digital documents as proprietary, competition-sensitive, or “For Official Use” only. However, these designations are merely deterrents, and not secure systems for managing access to such documents. Another method is to encrypt documents only with passwords, but the passwords and files could be given away to unauthorized individuals.

Moreover, securing a “Trusted Information Network” to store information raises issues and concerns about network access. If someone gains access to that network, or if someone internally uses credentials maliciously, any file to which that person has access can be removed from the protection of the secure network and given away without attribution. This is particularly applicable when information technology (IT) regulations permit non-employees or other individuals to gain access to government or corporate networks.

An effective and secure network system must provide convenient access to continuously updatable information for authorized users, while taking appropriate safety measures to prevent data breaches and providing an efficient and accurate way to trace any breach. Consequently, there is a need for a dedicated, secure, standards-based security system that is low in cost (administrative and infrastructure), easy to use and administer, requires minimal setup time, is highly reliable and available to provide universal access to stored information, and is secure from outside attacks (e.g., hackers, public cloud or Internet service provider personnel, etc.) and from inadvertent or malicious insider actions with attribution in the event of misuse.

### SUMMARY OF THE INVENTION

The present invention relates to a system and method for secure document distribution. The system includes a computer system and a secure document distribution engine. The system includes a two-factor authentication system that includes a password and a hardware component. Documents can be accessed from a network (e.g., the Internet, a cloud computing resource, etc.), via a link as an e-mail attachment, or as a stored file. Redistribution of documents by malicious authorized users is not possible without attribution due to the view-only nature of the system in combination with other measures that include event logging and document watermarking. Access can be revoked or blocked in real time, regardless of how the files were distributed or where they reside.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing the overall infrastructure of the secure document distribution system of the present invention;

FIG. 2 is a diagram showing overall function, control, and management options for a user of the secure document distribution system;

FIG. 3 is a flowchart showing general processing steps for registering with and accessing the secure document distribution system of the present invention;

FIG. 4 shows a user registration screen requiring the user to provide an email address, a strong password, and at least one hardware component;

FIG. 5 shows an email and generated hashed token to verify a user's e-mail account;

FIG. 6 is a diagram illustrating four types of users that can utilize the secure document distribution system and their corresponding abilities within the system;

FIG. 7 shows screenshots illustrating various ways a user can access secured documents;

FIG. 8 shows a mobile application of the secure document distribution system;

FIG. 9 shows a mobile application of the secure document distribution system on a tablet computer;

FIG. 10 shows screenshots of user interface screens generated by the system for allowing a user to upload a document to the cloud;

FIG. 11 shows a screen generated by the system for allowing an owner to designate or modify user privileges;

FIG. 12 shows a screen generated by the system that allows an owner to manage users;

FIGS. 13-14 are screens generated by the system for allowing an owner to manage GPS locations from which a user can access a particular secured document;

FIG. 15 shows a general overview of the security features employed by the secure document distribution system;

FIG. 16 shows an exemplary passphrase generated by the system;

FIG. 17 is a flowchart showing login processes carried out by the system of the present invention;

FIG. 18 is a flowchart showing processes for registering a user with the system;

FIG. 19 is a flowchart showing processes for allowing a user to control access to the system;

FIG. 20 is a flowchart showing processes for allowing a user to verify and list the SCOIs to which the user has access, store an encrypted SCOI file to a disk, and/or decrypt a stored SCOI file from a disk;

FIG. 21 is a flowchart showing processes for allowing a user to contribute to and/or moderate an SCOI;

FIG. 22 is a flowchart showing encryption and decryption processes carried out by the system; and

FIG. 23 is a diagram showing hardware and software components of the system of the present invention.

### DETAILED DESCRIPTION OF THE INVENTION

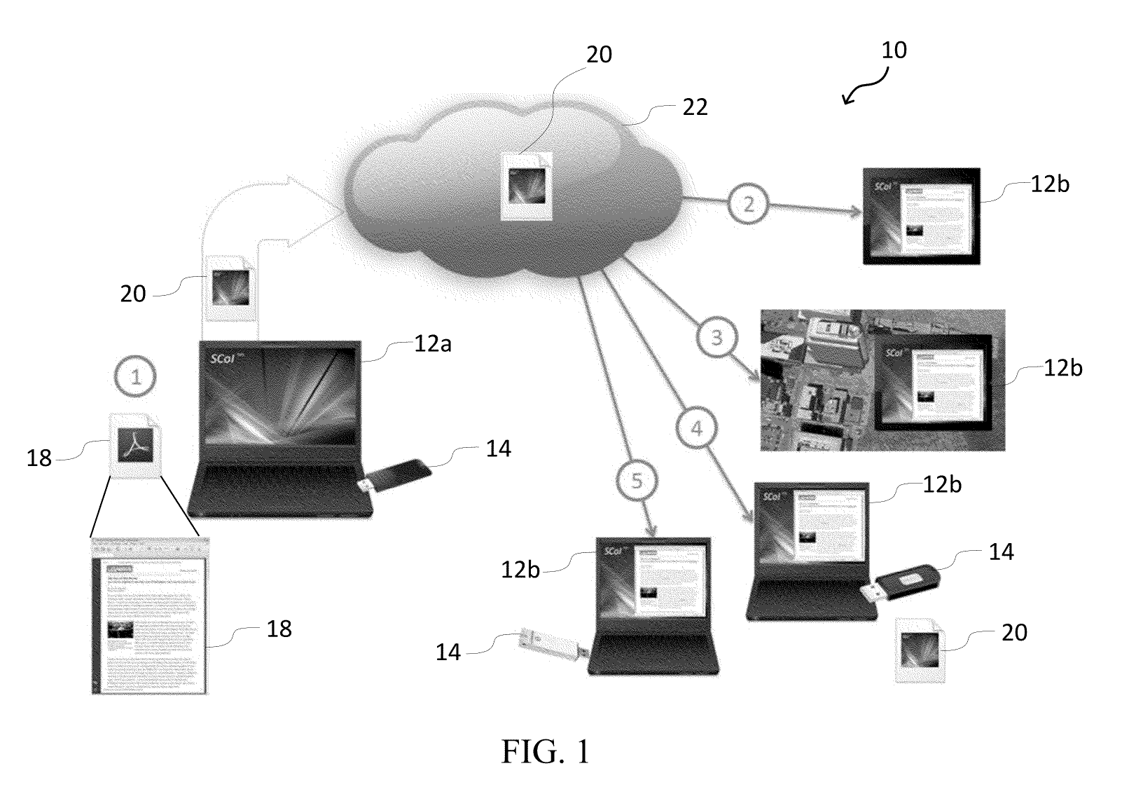

The present invention relates to a system and method for secure document distribution, as discussed in detail below in connection with FIGS. 1-23. The secure document distribution system provides universal mobile/remote access to shared and potentially confidential information for teams (large or small), while facilitating control over, and mitigating data breaches for, internally or externally distributed documents. The secure document distribution system provides an information-sharing environment for securely distributing documents, controlling who can view the document and how they can view it, protecting the documents from loss to external users or insider threats, and ensuring that the viewer of the document cannot further distribute it without attribution. It is noted that the term “cloud,” as used herein, refers to a distributed, networked computing resource as such term is commonly understood by those of ordinary skill in the art.

FIG. 1 is a general diagram showing the overall infrastructure of the secure document distribution system 10 of the present invention. Use of the secure document distribution system 10 requires an Internet accessible computing device, such as a computer or laptop 12a (e.g., running Windows or Macintosh operating systems), a tablet computer (e.g., iPad), a smartphone (e.g., iPhone, Android), or any other computing system with Internet connectivity for secure information sharing in the public cloud 16 (e.g., using Amazon's AWS S3 storage service). The computing device 12a includes an internal or external storage device 14 (e.g., USB thumb drive). As explained in more detail below, using a registered and authorized computing device 12a, a document 18 (e.g., PDF document) is encrypted and converted to a secured document 20, and then transferred to the public cloud 22. The document 20 can be accessed by other authorized users within a secure community of interest (SCOI) via other registered and authorized Internet accessible computing devices 12b having at least one registered hardware component 14. The computing devices 12b could be similar, or identical, to the systems 12a discussed above, e.g., they could be laptop computers, tablet computers, smart phones, etc.

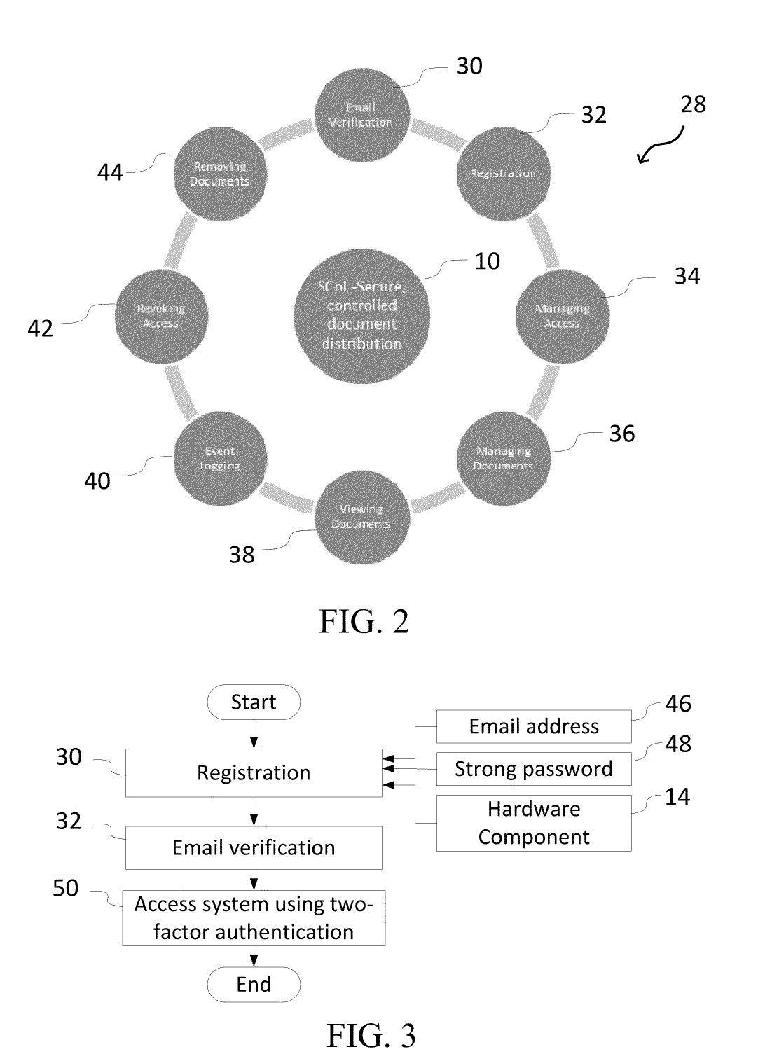

FIG. 2 is a diagram showing overall function, control, and management options 28 for a user of the secure document distribution system 10. The options 28, discussed in greater detail below, include email verification 30, registration 32, managing access 34, managing documents 36, viewing documents 38, event logging 40, revoking access 42, and removing documents 44.

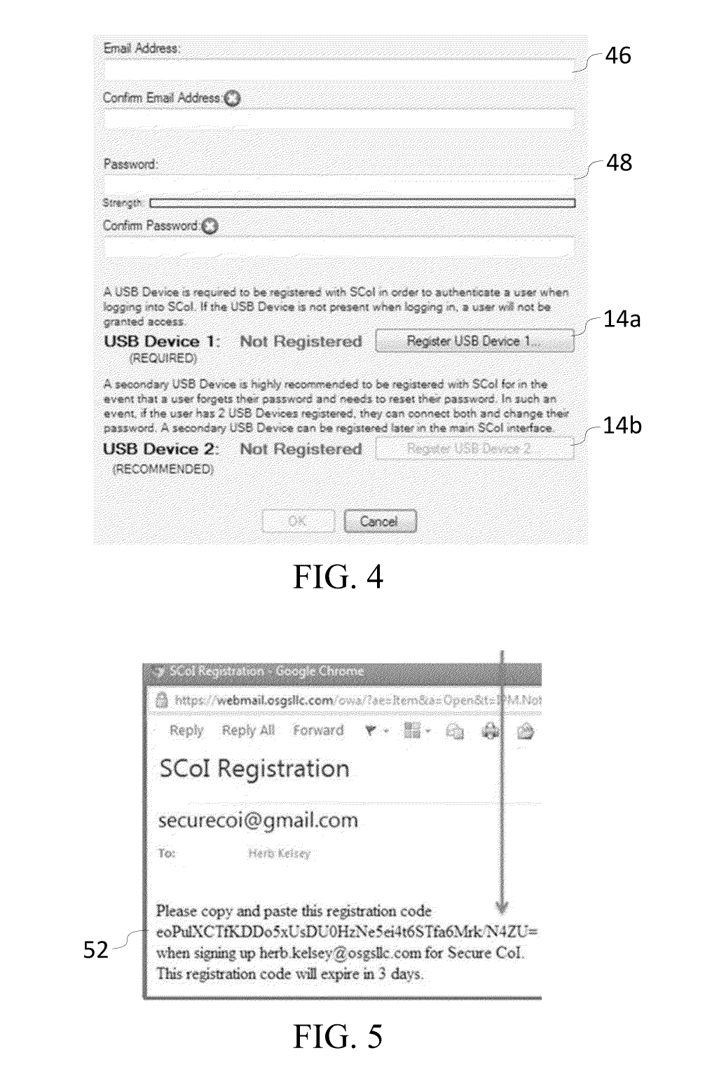

FIG. 3 is a flowchart showing processing steps for registering with and accessing the secure document distribution system 10 of the present invention, and FIGS. 4-5 are associated therewith. Starting in step 30, a user registers by identifying himself/herself with an email address 46, a strong password 48, and at least one hardware component 14, as shown in FIG. 4. The user may also register a second hardware component to support password resets or the potential loss of the primary hardware component 14.

In step 32 of FIG. 3, and as shown in FIG. 5, a hashed token 52 is generated and sent to the user's e-mail account. The hashed token 52 must be retrieved to verify the user's email address 46 and complete the registration process. This reduces the likelihood that a user's e-mail address 46 is used by an unauthorized person. In step 50, after registration, the user may sign into the secure document distribution system 10 using a two-factor authentication system including the strong password 48 and the hardware component 14, described in more detail below.

Once registered and authenticated, a user can establish secure communities of interest, hosted by the system 10, which allows other registered users to access documents stored therein. A secure community of interest (SCOI) comprises a community or team of users authorized to share a particular repository of information stored in the public cloud. As explained in more detail below, users share information only with those members they choose for as long as they choose and deciding to share information with selected users does not allow them to distribute the information to others on behalf of the user of origin.

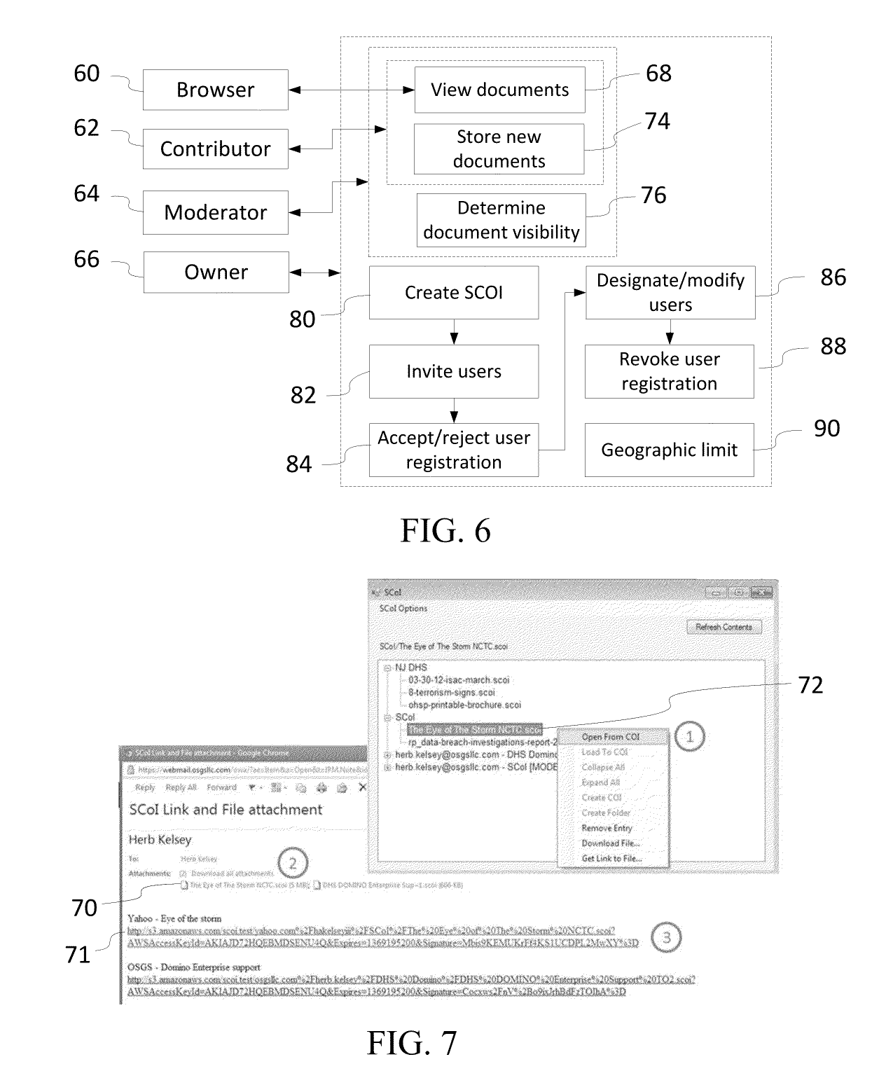

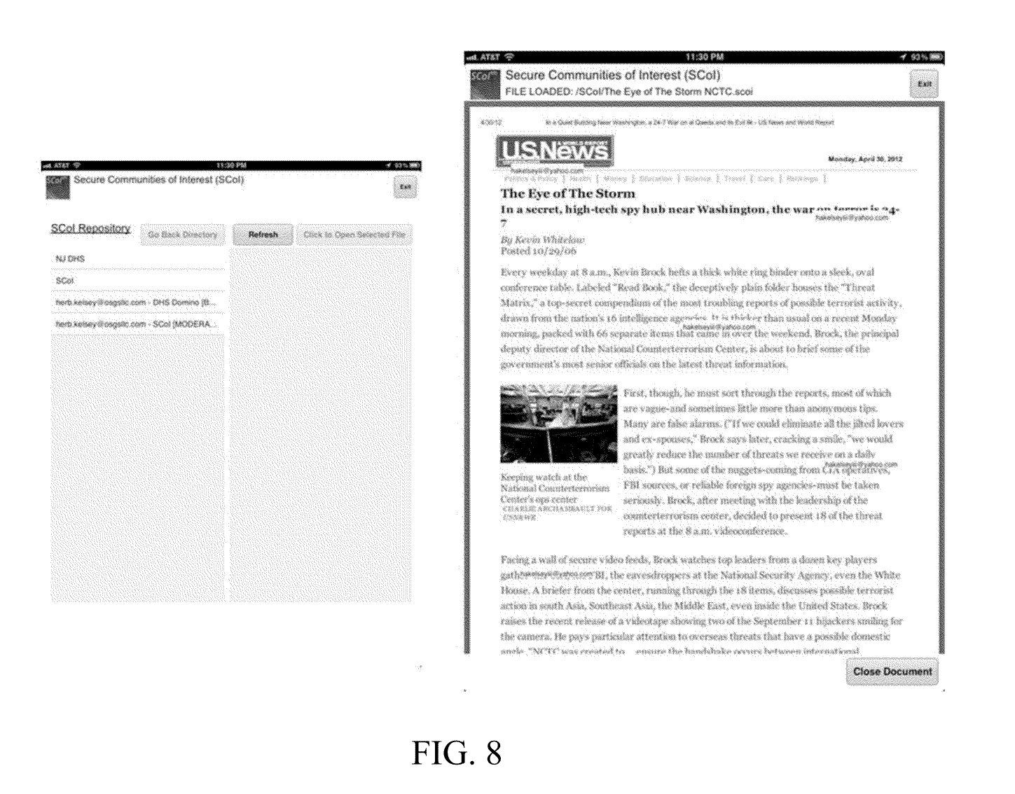

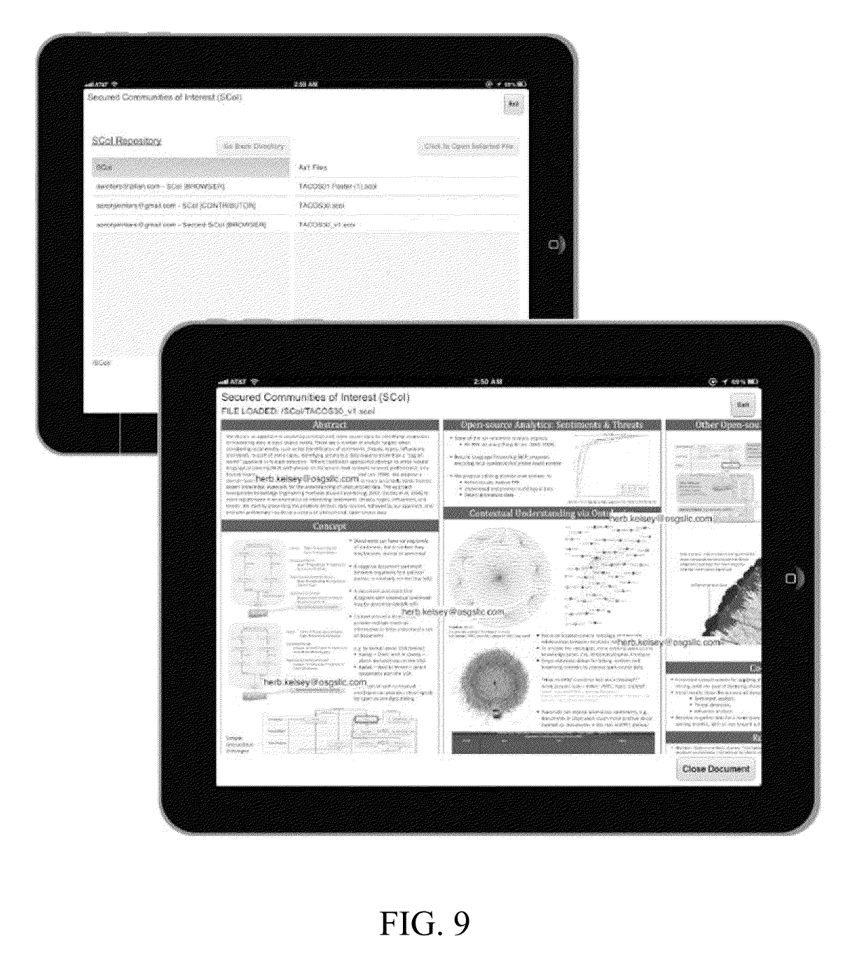

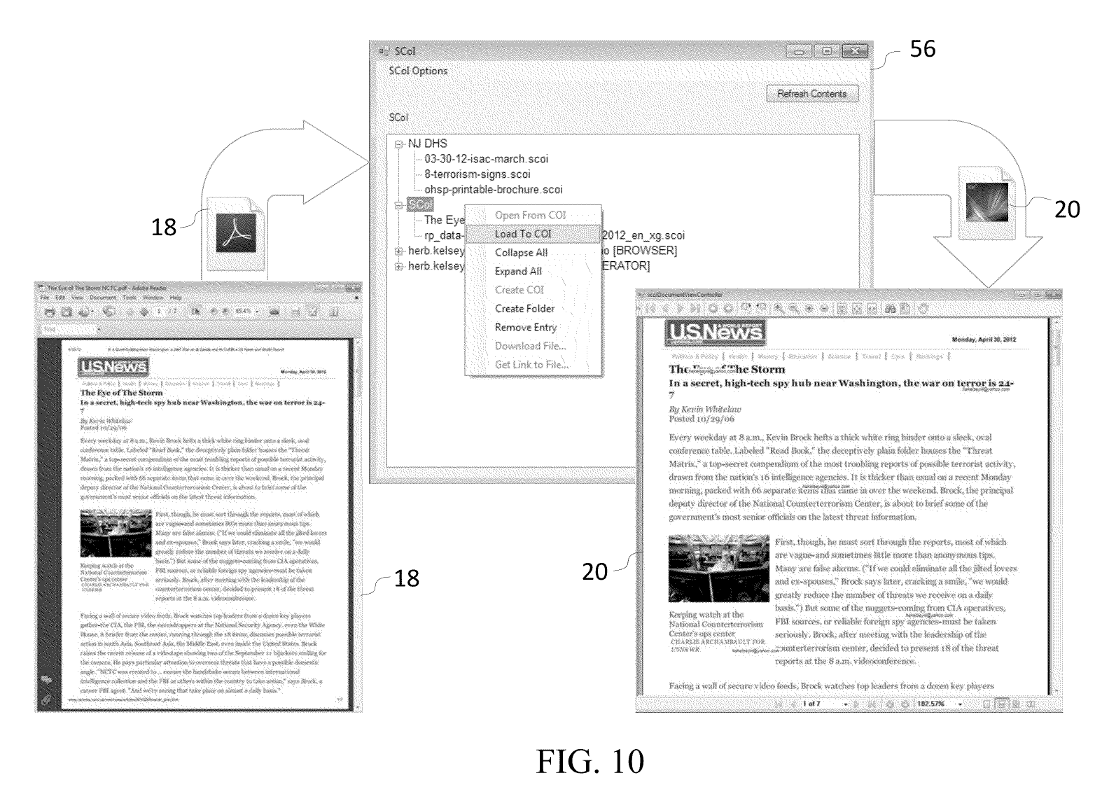

FIG. 6 is a diagram and flowchart showing four types of users that can utilize the secure document distribution system and their corresponding abilities within the system, and FIGS. 7-14 are associated therewith. The users include browsers 60, contributors 62, moderators 64, and owners 66. Browsers 60 have “view” access to view documents 68 and information in the community of interest. Document access requires an Internet connection, and is verified by receiving proper login credentials and determining if the owner still allows the user access to the community of interest of the desired document. As shown in FIG. 7, documents can be accessed from the cloud, via a link 70, as an e-mail attachment 71, or a stored file 72 downloaded from an SCOI to which the user has access. Links 70 can be set to expire and require user authentication before the document is retrieved from the public cloud for viewing. The viewing application decrypts documents in memory so that at no point are unencrypted documents stored on disk. The secure document distribution system may be accessed via a computer or, as shown in FIG. 8, via a mobile device. FIG. 9 shows the secure document distribution system accessed from a tablet computer (iPad). Although a user can forward an SCOI link or an attached SCOI document, or distribute a stored SCOI document, whoever receives the link or document must still receive authorization from the owner before they can view the document.

Contributors 62 can view documents 68 and also store new documents 74 within a secure community of interest. When a contributor 62 adds a new document 74, it is stored and not made public to the team or authorized users until it is reviewed by a moderator 64. FIG. 10 shows a screen 56 of the secure document distribution system by which a user uploads a document to the cloud. As shown, the user chooses a document 18, and then the system encrypts and converts it to a secure document before storing it on the cloud.

Moderators 64, in addition to the capabilities of browsers 60 and contributors 62, determine the visibility of documents 76, including stored documents, to authorized users. Stored documents are not made public to the team until a moderator 64 reviews the document to ensure that the information should be made available to one or more authorized and registered members. In this way, the moderator 64 determines whether the document should be entirely or partially visible, and to whom it should be visible. When a moderator 84 adds a document, the moderator 84 has the option of classifying the document for public viewing or as a “moderated document,” where a moderated document includes changes to the document's visibility, but not its contents. Explained in more detail below, a moderator may remove a document so that even if the secure document distribution system has no control over the cloud's disposal mechanism, the file remains encrypted and inaccessible to any cloud infrastructure personnel.

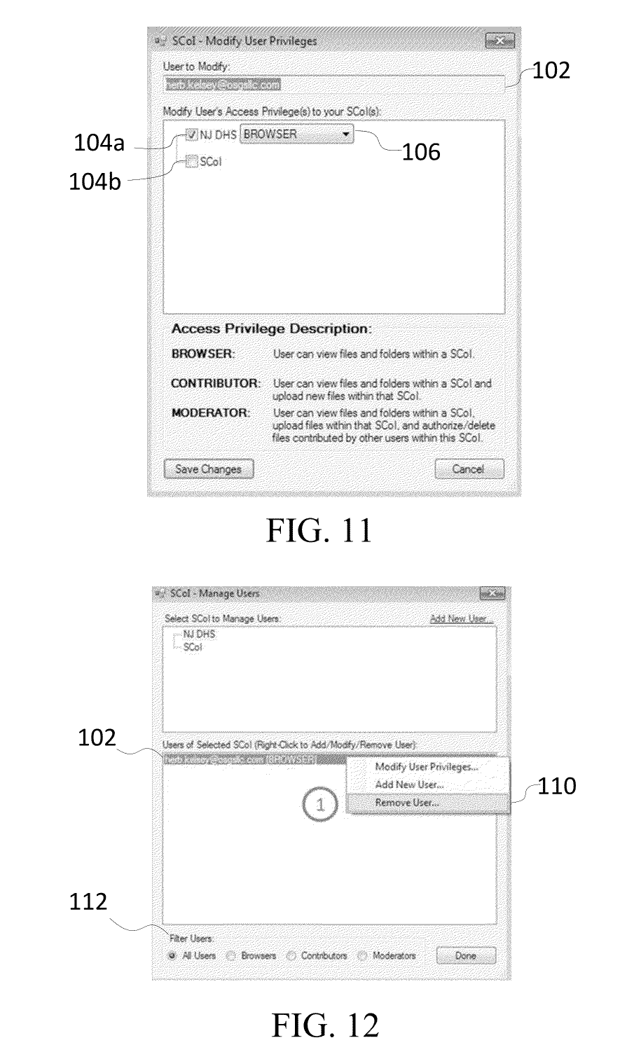

An owner 66 creates an SCOI 80, and for every SCOI there is only one owner 66. In addition to the abilities of the moderator 64, an owner 66 has the non-delegable responsibility to invite users 82 to register. After a user registers with the secure document distribution system 10, he/she identifies him/herself to the owner with an email address, password, and hardware component 14 of the device 12 he/she is using to access the public Internet and public cloud 22. The owner then accepts or rejects the registration of the prospective user 84, which is a non-delegable responsibility. Once the owner 66 accepts a user's registration 84, the owner can then designate, and subsequently modify, the user 86 as Browsers, Contributors, or Moderators, as shown in FIG. 11. An owner 66 can modify privileges 86 by choosing a particular user 102 from the “User to modify” field of a “modify user privileges” screen. The owner 66 could then edit which SCOI that user 102 has access to (such as by checkboxes 104a-b) and/or modify the designation of a particular user (such as by dropdown box 106). Also, an owner 66 can restrict how many documents can be viewed in a day to restrict mass viewing of documents in SCOI.

After the user 102 is accepted by the owner 66, the user 102 can view the SCOI files 68 using the hardware component 14 registered with the system 10. In this way, if the user 102 registered a USB thumb drive, the user 102 would be able to access the system 10 from any computer that has access to the public Internet and an available USB port to accept the thumb drive with which they registered.

An owner 66 can modify or immediately revoke a user's registration 88 (as shown by element 102 in FIG. 12) in real time for any reason, regardless of how the files were distributed (e.g., user has an existing link, stored an email attachment, or downloaded an SCOI file), or whether they reside in the cloud or on an end user's disk drive. An embodiment of this is shown in FIG. 12, where an owner 66 could choose a particular user 102 and then remove the user from an edit box 110. Further, an owner 66 could filter users 112 so that only users of a particular designation are shown. For instance, an owner 66 could revoke a user's access because the owner 66 determines that there has been an increase in the end user's risk factors (e.g., excessive number of failed logins, attempts to view an unusually high number of documents, loss of access keys, attempts to view documents from outside authorized GPS locations, etc.). Once a user is revoked, he/she no longer has the ability to browse, view, or access documents contained in the SCOI, including currently open documents. A user (not an owner) can lose access to a document if he/she removes the registered device 14, loses his/her Internet connection, moves outside of a GPS hotspot, access is revoked by an owner, and/or behavior occurs outside of the owner's policy. An owner can also lose access to a document if he/she removes his/her registered device 14 and/or loses his/her Internet connection.

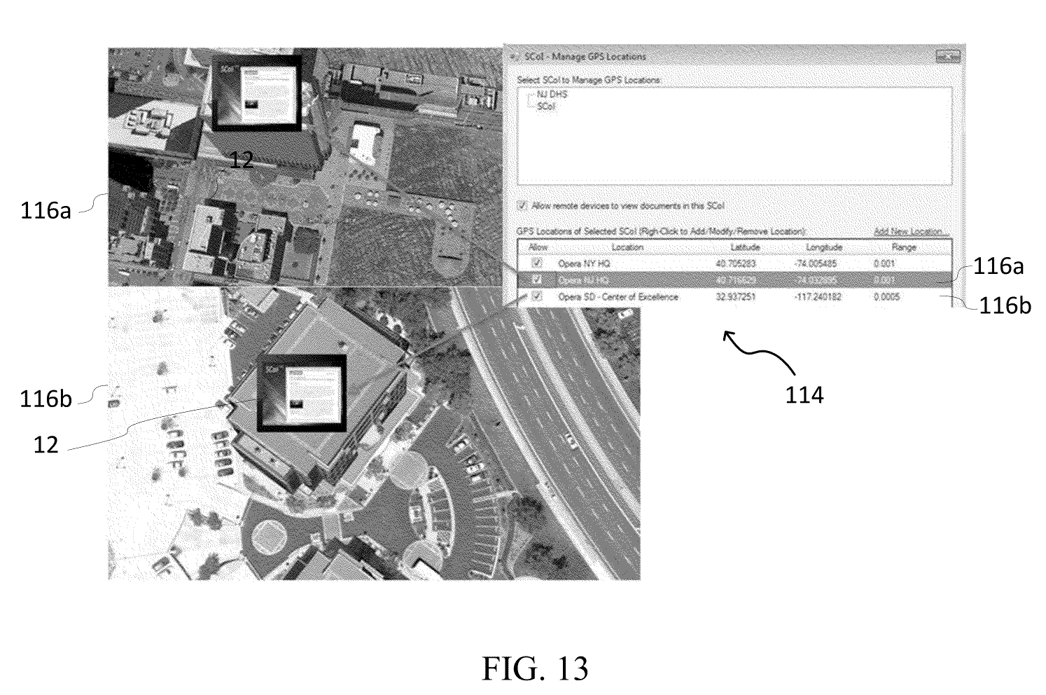

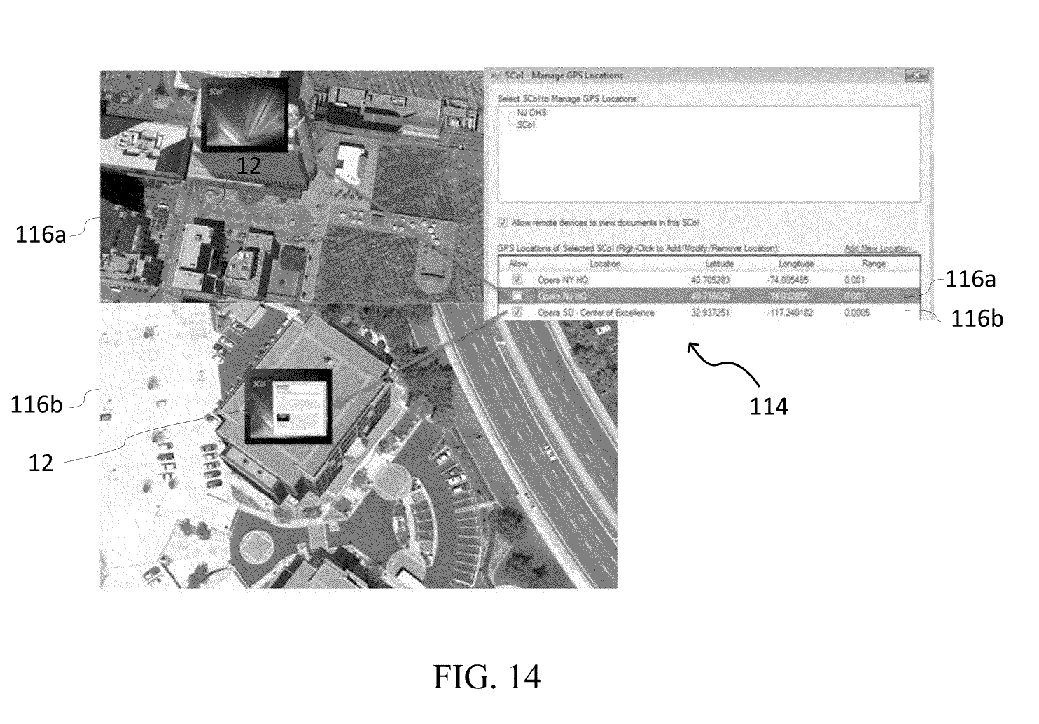

An owner 66 also has the ability to set a geographic limit 90 or “GPS hotspot” by which a user can access documents contained in the SCOI. The owner 66 may restrict viewing to a specific geographic location by restricting access to a specific external IP address range or to specific GPS location for mobile devices. Geographic restriction is shown in more detail in FIGS. 13-14 in the “Manage GPS Locations” window 114 where the owner 66 can set a location name, a latitude, longitude, and acceptable range therefrom, and then choose whether to allow access from that location (such as by a checkmark box). In FIG. 13, the owner 66 allows a particular SCOI to be accessed from locations 116a and 116b and, as depicted, the secure document distribution system is accessible from both locations. However, in FIG. 14, the owner 66 disallows location 116a and, as depicted, the secure document distribution system is inaccessible from that location, but still accessible from location 116b.

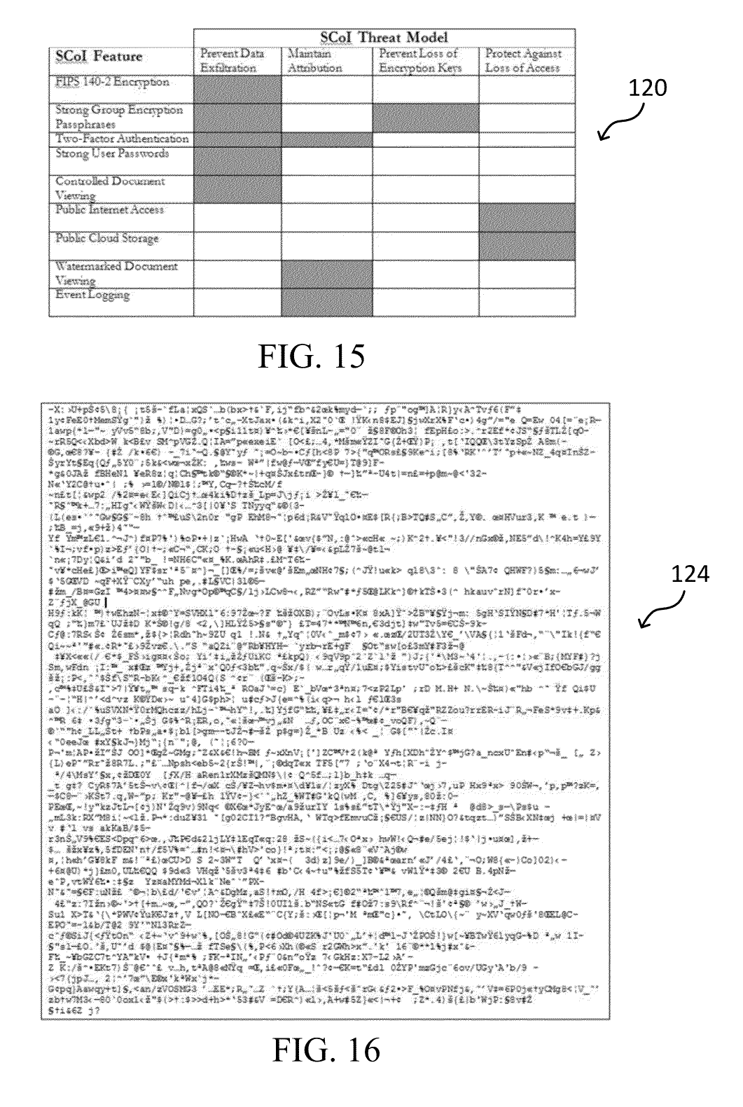

FIG. 15 shows a general overview of the security features employed by the secure document distribution 10, expressed as a threat mode. The threat model contains four prioritized elements. First, and foremost, the secure document distribution system 10 prevents information loss that could result from an outsider or insider threats (e.g., external hacking, deliberate misuse by a malicious insider, public cloud or Internet Service Providers' personnel), whether inadvertent or by deliberate internal misuse. In a preferred embodiment, as shown, the system 10 fulfills this element by utilizing FIPS 140-2 Encryption, strong group encryption passphrases, two-factor authentication, strong user passwords, and controlled document viewing. Second, the system 10 maintains attribution in the rare event valuable information is given to an unauthorized user that is easy to trace quickly and directly to an individual. In a preferred embodiment, as shown, the system 10 fulfills this element by two-factor authentication, watermarked document viewing, and event logging. Third, the system 10 protects against the loss of encryption keys. In a preferred embodiment, as shown, the system 10 fulfills this element by strong group encryption passphrases. Fourth, the system 10 protects against the loss of, or loss of access to, information. In a preferred embodiment, as shown, the system 10 fulfills this element by public internet access and public cloud storage.

The two-factor authentication system required by users to access the secure document distribution system 10 provides two different layers of security. Typical barriers to an efficient and effective authentication system for a secure information sharing environment are infrastructure, cost overhead, and administrative overhead (i.e., management). The two-factor authentication system overcomes these barriers and represents a high security to cost ratio solution to control the distribution of documents. The two-factor authentication system includes the strong password 48 and the hardware component 14, discussed above, as registered by the user and required by the system 10. This increases the difficulty for a potential hacker to breach the system because the hacker would have to breach both hardware and software boundaries. Once registered, users may access the system using their password 48 and registered hardware component 14, which are read by the system 10 to authenticate the user. However, to prevent brute force password attacks, a user must restart the application after three unsuccessful login attempts.

The strong passwords 48 preferably meet bit entropy standards (e.g., National Institute of Standards and Technology (NIST)), which are required to support log-in access to Controlled Unclassified Information (CUI) documents. See Joshua Bolten, “Memorandum to the Heads of all Departments and Agencies: E-Authentication Guidance for Federal Agencies,” http://www.whitehouse.gov/sites/default/files/omb/memoranda/fy04/m04-04.pdf., the entire disclosure of which is expressly incorporated herein by reference. On average, an attacker will have to try half of the possible passwords before finding the correct one. Password strength is influenced by a number of factors (e.g., size of the character set, sequences of characters, mixture of character types, length, and repetition) and is usually estimated in terms of information entropy measured in bits. Instead of the number of guesses needed to find the password with certainty, the base-2 logarithm of that number is given, which is the number of “entropy bits” in a password. For instance, a password with 42 bits of strength would be as strong as a string of 42 bits chosen randomly or, put another way, a password with 42 bits of strength would require 2⁴² attempts to exhaust all possibilities during a brute force search. Thus, adding one bit of entropy to a password doubles the number of guesses required, which makes an attacker's task twice as difficult. The strong password 48 is stored as its hashed value, not a clear text string. As a result, the system 10 cannot retrieve a lost password for a user. In the event of a lost password, the user is required to verify their identity with a registered hardware component at which time they have the opportunity to change their password. Encryption and hash generation for information stored by the secure document distribution system 10 (e.g., user security information, passwords, hardware keys, etc.) is preferably Microsoft FIPS 140-2 compliant (a requirement for federal systems handling Sensitive But Unclassified (SBU) data).

As discussed above, a user must register at least one hardware component 14, at which time the hardware component's unique identifier (e.g., Universal Unique Identifier (UUID) or Unique Device Identifier (UDID)) is associated with the user. As mentioned above, the hardware component 14 could be external to the Internet accessible device 12, such as a USB thumb drive, or internal to the device 12, such as for mobile devices like smartphones (e.g., Apple iPhone) or tablet computers (e.g., Apple iPad). Exemplary USB thumb drives include those approved by the Department of Defense (e.g., Iron Key). Although a password can be given away without attribution regardless of password strength, a physical device is associated with its registered owner, and thus provides a reliable starting point for identifying malicious insider behavior. The user may use the hardware component 14 and/or Internet accessible device 12 for other purposes beyond user authentication since the system 10 does not use the hardware component 14 or device 12 for storage of documents or encryption keys. While registered users can still intentionally provide their email, password, and registered thumb drive to another party, these are not anonymous acts, as any breach of access can be attributed to the registered user.

As mentioned above, the user may also register a second hardware component to support password resets or the potential loss of the primary hardware component. Loss of a registered hardware component 14, without knowing the corresponding password, does not compromise the system 10 because the user would simply re-register with the owner 66 using a new hardware component 14 or authenticate with the second hardware component 14. In such a case, registration of the lost hardware component 14 is revoked and the user has the opportunity to register an additional hardware component 14 to allow them to reset their password 48.

For a user to add documents to the public cloud, as discussed in FIG. 10, the secure document distribution system encrypts and then transmits documents over the public Internet for storage in the public cloud. Documents are preferably AES 256-bit, CBC encrypted using Microsoft FIPS 140-2 validated cryptographic modules, and a SHA256 hashing algorithm. Each SCOI has a unique encryption passphrase, which are generated only when the document is being viewed. The passphrases are 4,000 characters long over a 256-bit character set to provide enough bit-entropy (i.e., password strength) to at least match that of AES-256 encryption. FIG. 16 shows an exemplary passphrase comprising a length of 4096 of a 255 bit character set with a bit entropy of 24,587 bits, thereby requiring 2^{24,587} attempts to guess.

Data at rest in the cloud is encrypted and data is transmitted to the user encrypted, so that at no time are clear text documents transmitted and any file replicated by the public cloud infrastructure remains encrypted. Thus, hackers are unable to view information when it is moving over the Internet or while it is at rest in the public cloud, and the private key (i.e., encryption passphrase or decryption pass key) remains secret because the encryption keys used by the system are never distributed or stored. This eliminates a user's ability to accidentally (e.g., via phishing) or maliciously provide them to an unauthorized user. This avoids the security risk of losing the keys or having them intercepted, and also avoids large administrative and infrastructure costs normally associated with secure distribution and securing the content of the encryption keys. Additionally, since keys are not distributed, users have a high degree of confidence that the information they are viewing was provided by an authorized user of the system.

When retrieved, the documents remain encrypted until being viewed, where the documents are decrypted in memory by the viewing software so that the documents are never stored to disk (i.e., on the cloud or on an end-user system). Users have no way to decrypt an SCOI document without the secure document distribution system. The secure document distribution system is a read-only environment for the dissemination of properly marked, read-only material (e.g., PDF documents), not a source of documents to be edited or modified. In this way, the data is only displayed on the screen and never touches the hard drive of the machine or mobile devices, which prevents data loss by data ex-filtration and/or malicious use of the data (e.g., malicious insider threat, external intrusion, or external hacker masquerading as an insider). The viewing application restricts printing, saving/storing, copying (in whole or in part), distributing, and screen print functions of an unencrypted document. Also, in this way, .NET executables are obfuscated to discourage reverse engineering of the software.

Further, the owner may also specify that the viewer display a watermark for attribution purposes each time a file is decrypted (e.g., watermark consists of the viewer's e-mail address and external IP address). In this way, redistribution of documents, specifically clear text documents, by malicious authorized users is not possible without attribution.

Moreover, the secure document distribution system 10 can store a detailed event log, which uses coordinated universal time (UTC) to unify logs across user time zones (providing log accuracy from varied time zones) and captures the external IP address of the viewer. Exemplary logged events include successful and unsuccessful user authentications, opening a document, closing a document, the creation of a document link, the addition or removal of a document, the addition or removal of a user's access to an SCOI, etc.

The secure document distribution system 10 preferably uses public infrastructure (e.g., Amazon's S3 public cloud storage services and the public Internet), to provide reliable, scalable access to broad information. Many public cloud storage services, such as Amason's S3, backs up data in multiple locations. Denial of service of the infrastructure is mitigated by using the public internet to access the public cloud. In this way, if access via one ISP is denied, a user could access the data from another provider.

The document-centric security of the secure document distribution system 10 protects against the most prevalent data extraction techniques used by hackers and malicious insiders (e.g., key loggers, stolen or misused credentials, backdoors and command control, pretexting (being tricked to divulge information), phishing (social engineering), brute force, etc.). For an unauthorized user to access documents in SCOI, they must obtain both an authorized users password and their registered USB thumb drive. A malicious authorized user can provide their password and USB thumb drive to an unauthorized user, but the unauthorized user's access to documents will be attributed to the malicious, authorized user. The unauthorized user remains unable to redistribute unencrypted SCOI documents electronically. For a user (authorized or unauthorized) to distribute unencrypted SCOI documents, they would have to brute force the random 4,000 character passphrase, defeat the AES-256 encryption, or photograph the document displayed on screen and scrub each digital photograph of the attribution watermark.

Many types of groups can use the secure document distribution system including those who, for some period of time, require the use of information to perform a task for which the content and membership may change and must be secure during the task. Companies regularly create teams to respond to a government proposal, such as a Request for Proposal (RFP), where there are documents that a team needs to share that are proprietary or competition-sensitive to an individual company. While a teaming arrangement covers the legal obligation, the secure document distribution system would ensure that shared information remained secure and not forwarded inappropriately, either accidentally or deliberately. This is an instance of information-sharing in which competitive interests are sustained during and after the proposal, even as team compositions may change during the RFP and after the contract is awarded. The secure document distribution system is well suited for a group of researchers from different organizations who are collaborating on a topic. The system can provide a single, secure information-sharing corporate network for the group, while maintaining the security of the information. Access can be updated as the group changes in composition over time. The system addresses the need of corporations and the private sector to distribute proprietary company information, or otherwise sensitive documents (e.g., trade secrets, competition sensitive information, intellectual property, information subject to government regulation, pricing information, internal investigations, revenue forecasts, strategies, customer lists, etc.) that need to be protected from viewing by unauthorized individuals, or being redistributed or misused by authorized individuals. The system could be used when preparing for a board of directors meeting or communicating with legal counsel or amongst C-suite executives to better manage and secure sensitive information and protect from unauthorized disclosure or use by that corporation's employees and outside vendors, agents or brokers with whom the corporation does business.

The secure document distribution system 10 also enables government at the federal, state and local levels, in adherence to government policy, laws, and technical implementation guidance (e.g., NIST guidelines and OMB requirements), to securely distribute CUI (Controlled Unclassified Information) (e.g., “For Official Use Only” (FOUO) and Law Enforcement Sensitive (LES)) and SBU (Sensitive But Unclassified) documents via the public cloud and public Internet, such as to prevent disclosure through information act requests (e.g., Freedom-of-Information Act (FOIA)). The secure document distribution system can be used for implementing regulatory document controls for Health Insurance Portability and Accountability Act (HIPPA), Sarbanes Oxley, Family Educational Rights and Privacy Act (FERPA), Controlled Unclassified Information (CUI), etc. Documents may be distributed to authorized governments, contractors, and civilian users without the need for access to secure government networks. Federal, state, and local government entities often share sensitive information with other government entities or trusted private sector partners in the form of bulletins and alerts. The secure document distribution system would allow the sharing of such information and prevent disclosure to unauthorized individuals (e.g. members of the press). Moreover, information shared through the secure document distribution system would have further protection from disclosure through an information request filed pursuant to statute (e.g. FOIA).

In support of an election campaign, the campaign manager could establish and create an SCOI. The candidate and direct staff would be moderators, while general staff and consultants would register as contributors and browsers. The system would allow the campaign to safeguard policy and position papers, travel plans, opposition research, etc. The system was designed from the outset with built-in support for absolute security concurrent with the highly dynamic teaming that takes place during a campaign. The secure document distribution system provides easy mobility to support the multiple locations utilized by statewide or national campaigns.

For teachers, teaching assistants, and students, the secure document distribution system can be used as an effective tool for sharing information with the class, or sending in papers to be seen just by the moderators (teaching assistants) or owner (teacher). However, users should note that it is not suitable for transmitting information to individual students. Inherently, such information should not to be shared with all members.

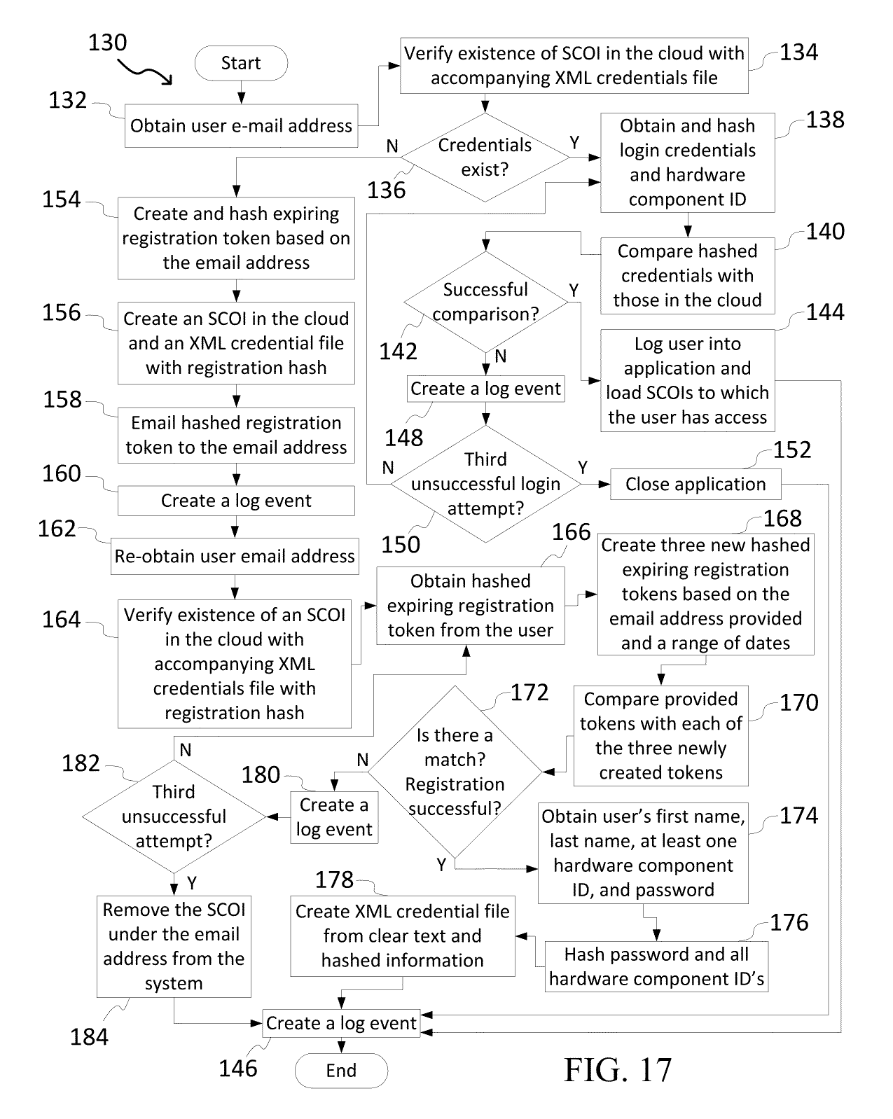

FIGS. 17-22 are flowcharts, respectively, of login processes, access registration and related processes, and encryption/decryption processes carried out by the system of the present invention. Turning now to FIG. 17, process steps are shown for handling user logins. The process starts in step 132, where the system obtains a user's email address and then, in step 134, verifies the existence (or non-existence) of an SCOI in the cloud with the accompanying (or absent) XML credentials file. In step 136, if the credentials exist, then the process proceeds to step 138, where the system obtains login credentials and a hardware component ID (e.g., USB device ID or mobile device ID) and then hashes those credentials (e.g., using SHA256). In step 140, the hashed credentials are compared with those stored in the cloud, and in step 142, a determination is made as to whether the comparison was successful. If the comparison is successful, then in step 144, the user is logged into the application, the SCOIs to which the user has access are loaded, and a log event is then created in step 146, creating a record of the user accessing the system.

If, in step 142, the comparison was not successful, then in step 148 a log event of the unsuccessful login is created. In step 150, a determination is made as to whether the failed attempt was the third (or greater) unsuccessful login attempt. If the attempt was less than three failed attempts, the process repeats from step 138. If the attempt was three or more failed attempts, the application closes itself in step 152, and then a log event is created in step 146.

If, in step 136, the credentials do not exist, then in step 154, an expiring registration token (preferably using the UTC date) for the email address is created and hashed (e.g., using SHA256). For security reasons, this step is preferably not accessible by mobile devices. Then, in step 156, an SCOI is created in the cloud, including a “.500” file, and an XML credential file with registration hash is created. The .500 file is a comma-delimited text string comprising a set of 500 random values. A unique .500 file is created for every SCOI, although it is anticipated that there could be one universal .500 file applicable to all SCOIs. The .500 file is used to help seed the encryption of SCOI documents. In step 158, the registration token is emailed to the email address provided by the user, and in step 160, a log event is created that a new SCOI is being registered. At this point in the process, a user could continue in the application and check his/her email immediately, or leave the application and then check his/her email and return to the application at a later time (e.g., some days later). In step 162, the system re-obtains the user's email address, and then in step 164 verifies the existence of an SCOI in the cloud with accompanying XML credentials file with registration hash. In step 166, the system obtains the hashed expiring registration token from the user (e.g., cut and pasted from the email), which will verify that the user has access to the provided email address. In step 168, the system creates three new hashed expiring registration tokens (assuming a three day expiration) based on the email address provided and a range of dates (e.g., for a three day expiring registration token, the range of dates is the current UTC date, one day prior, and two days prior). In step 170, the system compares the token provided by the user with each of the newly created tokens.

In step 172, a determination is made as to whether there is a match between the tokens (indicating a successful registration). If there is a match, in step 174, the system obtains the user's first name, last name, at least one hardware component ID (e.g., primary USB device ID, second USB device ID, user's mobile device ID, etc.), and a password (where the password is of an appropriate strength). Then, in step 176, the password and all of the hardware component ID's are hashed. In step 178, an XML credential file is created from clear text and hashed information, and in step 146, a log event is created, making a record of a properly registered SCOI.

In step 172, if there is not a match, then in step 180, a log event is created making a record of an unsuccessful attempt to register an SCOI. In step 182, a determination is made as to whether the attempt was the third (or greater) unsuccessful registration attempt. If the attempt was less than three failed attempts, the process repeats from step 166. If the attempt was three or more failed attempts, the system removes the SCOI under the email address from the system (allowing for re-registration of the SCOI for the email address) in step 184 and then creates a log event in step 146 that the registration for the SCOI was unsuccessful. Of note is the possibility that the system could carry out a separate trash collection sweep to remove empty SCOI's with expired registration hashes.

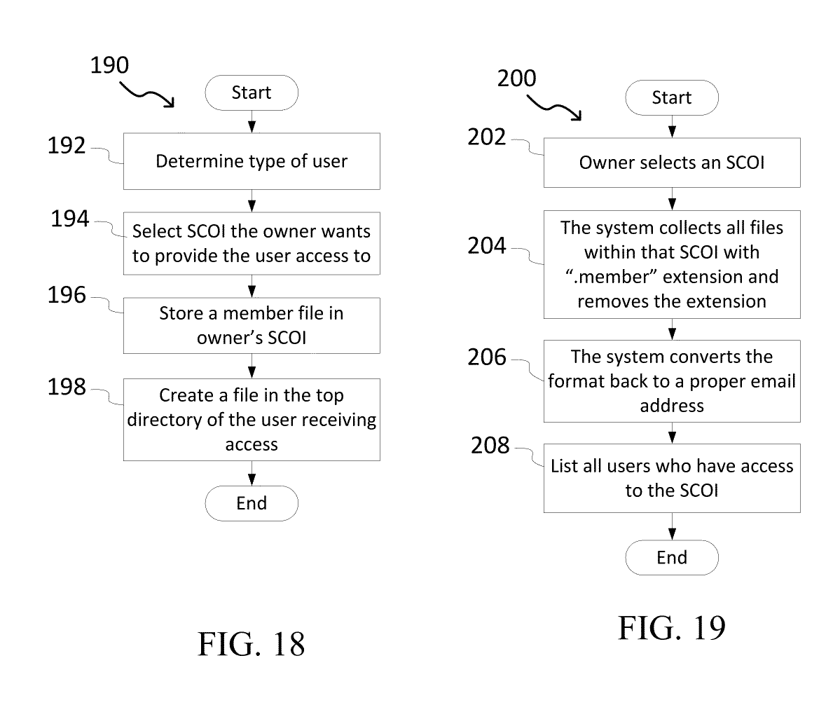

FIG. 18 is a flowchart showing processing steps, indicated generally at 190, for allowing an owner to register a user to access an SCOI. In step 192, the owner determines the user type to apply (e.g., browser, contributor, or moderator). In step 194, the owner selects the SCOI to which the owner wants to provide the user access, and then a membership file is stored in the owner's SCOI in step 196. The contents of the file include the user type (e.g., browser, contributor, or moderator), and the filename is represented as the user's email address in (-AT-) format with a “.member” extension. In step 198, in the top directory of the user receiving access, a file is created with the name of the full string to the SCOI and preferably having a “.access” extension. The file in the top level directory is simply an index to each of the SCOI's a user has been granted access, which facilitates for rapid accessibility of the SCOI and the contents therein. Of note, if a user is not registered, the proper file can still be created excluding the user's registration file, which allows an owner to give permission to an unregistered user.

FIG. 19 is a flowchart showing processing steps, indicated generally at 200, for allowing an owner to list all users who have access to an SCOI of the owner. In step 202, the owner selects an SCOI he/she owns. In step 204, the system collects all files with that SCOI with a “.member” extension and removes the extension. In step 206, the system converts the (-AT-) format back to a proper email address, and then lists all of the users who have access to that particular SCOI in step 208. If requested, the owner could also select one or more encrypted SCOI files and select one or more users and email the selected users with the selected encrypted SCOI files as an attachment.

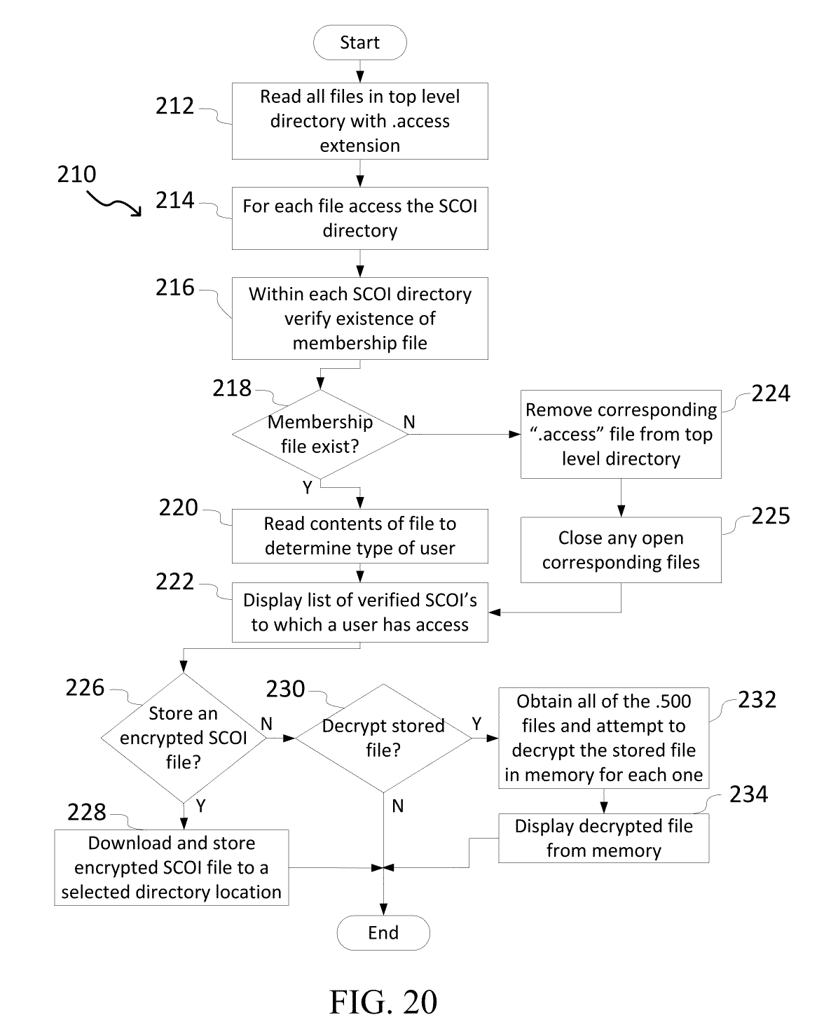

FIG. 20 is a flowchart showing processing steps, indicated generally at 210, for allowing a user to verify and list the SCOI's to which the user has access, store an encrypted SCOI file, and/or decrypt a stored SCOI file. In step 212, the system reads all files in the user's top level directory having a “.access” extension, and in step 214, the SCOI directory is accessed for each file (e.g., using the filename without the extension). In step 216, within each SCOI directory, the existence of a membership file is verified (preferably the file is in (-AT-) format with a “.member” extension). In step 218 a determination is made as to whether the membership file exists. If the membership file does exist, in step 220, the contents of the file are read to determine the user type given for that particular SCOI (e.g., browser, contributor, or moderator). If the file does not exist, in step 224, the corresponding .access file is removed from the user's top level directory, and in step 225, any open file from that SCOI is closed. In step 222, a list of verified SCOIs that a user may access is displayed. If requested, the contents of each of the accessible SCOIs may be listed. Also, if requested, the .500 files of each of the accessible SCOIs may be obtained.

In step 226 a determination is made as to whether the user desires to store an encrypted SCOI file. If so, in step 228 the user downloads and stores an encrypted SCOI file (from the list of accessible SCOI files) to a directory location chosen by the user. For instance, for a mobile device, this would be a “local” area defined by the device (e.g., Apple IOS environment).

If in step 226 the user does not want to store an encrypted SCOI file, another determination is made in step 230 where the user determines whether to decrypt a stored SCOI file from a disk. This assumes the application is registered with the Operating System to start when a file of the .SCOI extension is selected (e.g., application launches when .SCOI file is selected, or by mime/type, etc.). This also assumes the application is receiving the filename and location as a command line parameter. If so, in step 232 the system obtains all of the .500 files from the list of all of the SCOI's the user can access and attempts to decrypt the stored file in memory for each .500 file. Then in step 234, the decrypted file is displayed from memory (as if it was loaded directly from an SCOI). If in step 230, the user does not desire to decrypt a file, then the process ends.

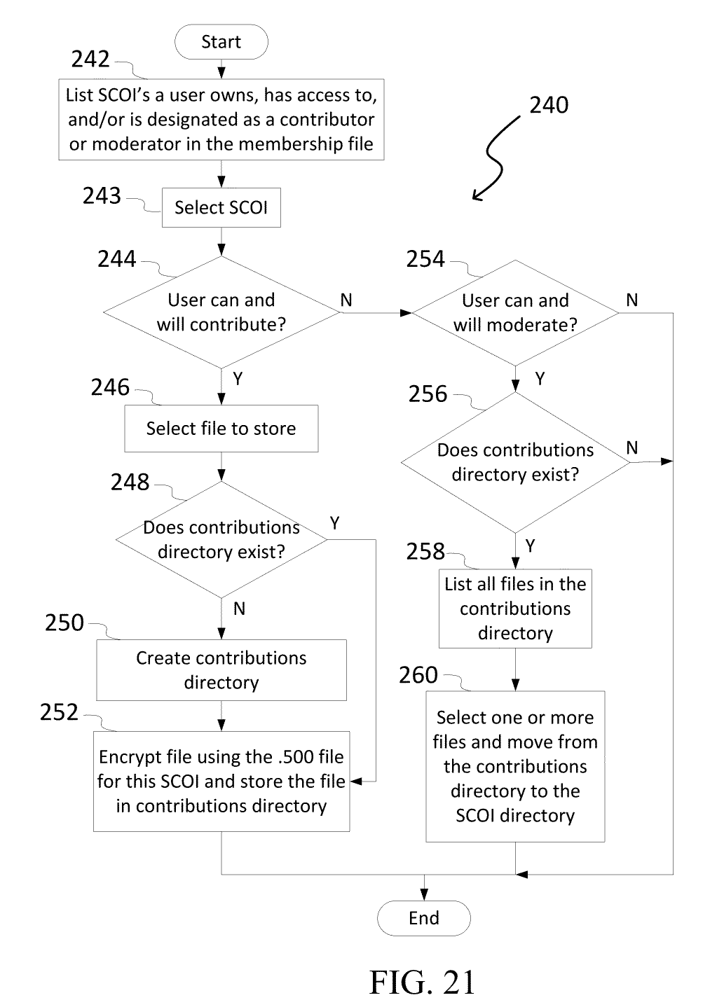

FIG. 21 is a flowchart showing processing steps, indicated generally at 240, for allowing a user to contribute to and moderate an SCOI. In step 242, a list is displayed which includes the SCOIs a user owns, has access to, and/or is designated as a contributor or moderator in the membership file. In step 243, the user selects an SCOI. In step 244, a determination is made as to whether a user can and will contribute to the SCOI. If so, in step 246, the user selects a file to store (e.g., PDF file). In step 248, a determination is made as to whether a contributions directory exists. If not, a contributions directory is created in step 250. In either case, the process proceeds to step 252 where the file is encrypted using the .500 file for the SCOI and the file is stored in the contributions directory. The files in the contribution directory could be invisible to browsers or contributors of the selected SCOI until moved from the contributions directory by a moderator or owner of the SCOI.

If, in step 244, the user does not wish to contribute, the process proceeds to step 254, where a determination is made as to whether the user can and will moderate the selected SCOI. If so, in step 256, a determination is made as to whether a contributions directory exists. If so, in step 258, all files in the contributions directory are listed, and in step 260, the user selects one or more files and moves the files from the contributions directory to the SCOI directory. If either of the determinations in steps 254 and 256 are negative, the process ends.

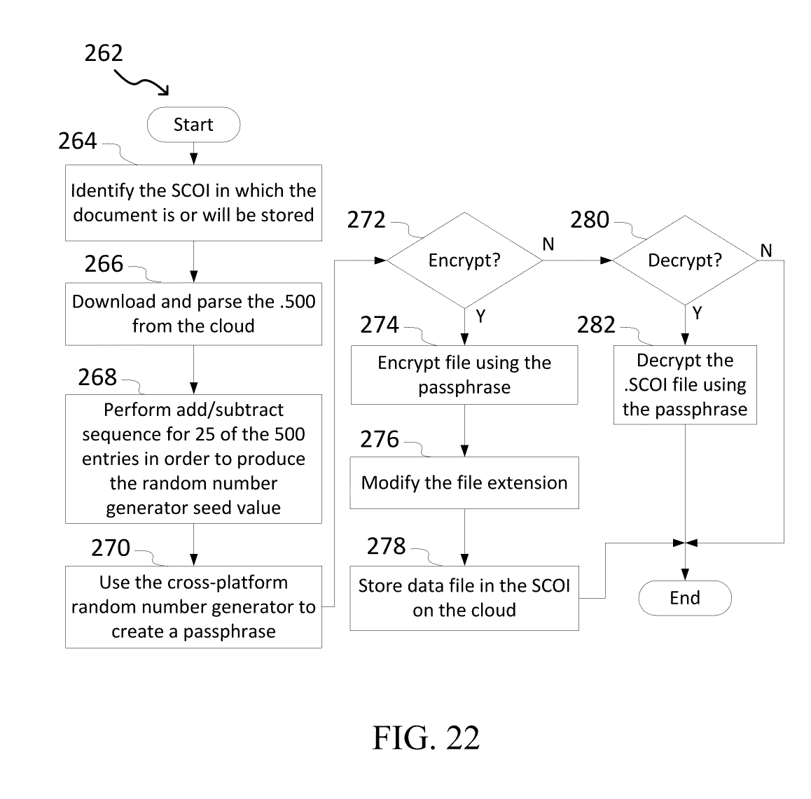

FIG. 22 is a flowchart showing processing steps, indicated generally at 262, for encrypting and decrypting files. In step 264, the SCOI in which the document is or will be stored is identified. Note that for decryption, identifying the SCOI in which the document is stored is easy if selecting the file from the cloud, but if sent via email, the link needs to be parsed. In step 266 the .500 file is downloaded from the cloud and parsed from a comma-delimited text string into an array. In step 268, add/subtract sequences are performed for 25 of the 500 entries in order to produce the random number generator seed value. The add/subtract sequence is generally used to create a range of random numbers that starts somewhere other than 0 by offsetting or shifting the starting point of the range. The random number generator seed value is an integer to set the starting point for generating a series of random numbers. In step 270, the cross-platform random number generator is used to create a strong passphrase (e.g., having 4096 characters). In step 272, a determination is made as to whether the user wants to encrypt a document (e.g., using .NET to ensure the use of FIPS 140-2 AES encryption). If so, the file is encrypted using the passphrase in step 274, the file extension is modified in step 276, the file is stored in the SCOI on the cloud in step 278, and then the process ends. If not, the process proceeds to step 280 where a determination is made as to whether the user wishes to decrypt a document. If so, the .SCOI file is decrypted in step 280 using the passphrase (e.g., 25̂2̂500). If not, the process ends.

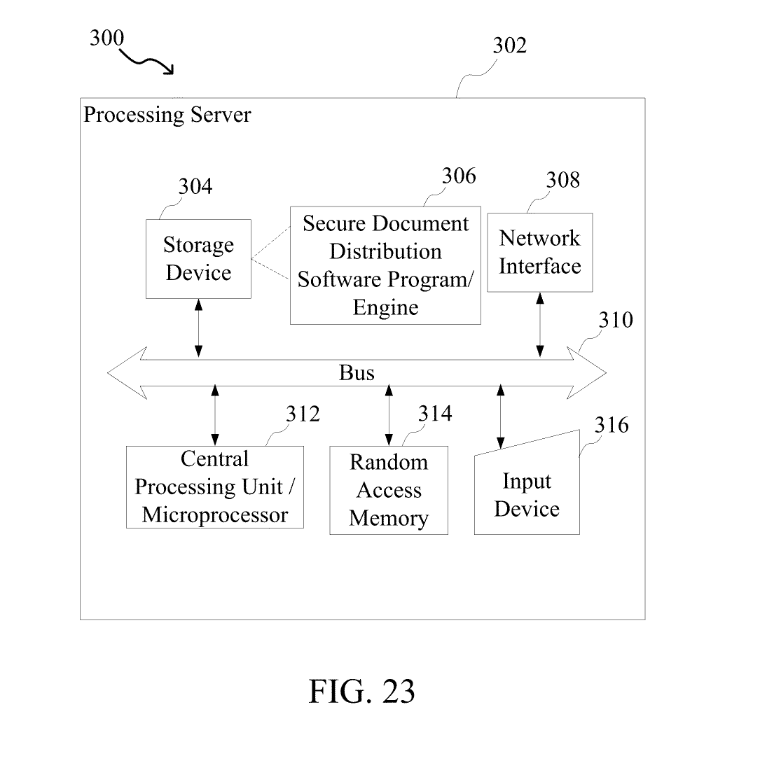

FIG. 23 is a diagram showing hardware and software components of a computer system 300 capable of performing the processes discussed in connection with FIGS. 1-22 above. The system 300 (computer) comprises a processing server 302 which could include a storage device 304, a network interface 308, a communications bus 310, a central processing unit (CPU) (microprocessor) 312, a random access memory (RAM) 314, and one or more input devices 316, such as a keyboard, mouse, etc. The server 302 could also include a display (e.g., liquid crystal display (LCD), cathode ray tube (CRT), etc.). The storage device 304 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 302 could be a networked computer system, a personal computer, a smart phone, etc.

The functionality provided by the present invention could be provided by a secure document distribution software program or engine 306, which could be embodied as computer-readable program code stored on the storage device 304 and executed by the CPU 312 using any suitable, high or low level computing language, such as Java, C, C++, C#, .NET, MATLAB, etc. The network interface 308 could include an Ethernet network interface device, a wireless network interface device, or any other suitable device which permits the server 302 to communicate via the network. The CPU 312 could include any suitable single- or multiple-core microprocessor of any suitable architecture that is capable of implementing and running the secure document distribution program 306 (e.g., Intel processor). The random access memory 314 could include any suitable, high-speed, random access memory typical of most modern computers, such as dynamic RAM (DRAM), etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for secure document distribution comprising:
a computer system in electronic communication with a plurality of users over a network;
a secure document distribution engine stored on the computer system and accessible to the plurality of users over the network, the secure document distribution engine providing read-only access to data associated with a secure community of interest to an authorized user of the secure community of interest;
wherein the authorized user of the secure community of interest registers a password and a hardware component with the computer system; and
wherein access by the authorized user to the data within the secure community of interest is controlled by the password and the hardware component such that access to the data is lost if the user removes the hardware component.

2. The system of claim 1, wherein the authorized user registers a username with the computer system.

3. The system of claim 2, wherein the username is an email address, and a user must retrieve a hashed token from the email address to complete registration.

4. The system of claim 1, wherein the system requires a minimum password strength.

5. The system of claim 1, wherein the hardware component is a USB thumb drive, smartphone, or tablet computer.

6. The system of claim 1, wherein the user loses access to data within the secure community of interest after revocation of a user's authorization.

7. The system of claim 1, wherein access to the secure community of interest is restricted by geographic location.

8. The system of claim 1, wherein data within the secure community of interest is encrypted and transmitted to an authorized user as such.

9. The system of claim 8, wherein a watermark is displayed each time data is decrypted.

10. The system of claim 1, further comprising a detailed event log of actions of registered users.

11. A method for secure document distribution comprising:
electronically communicating by a computer system with a plurality of users over a network, the computer system storing a secure document distribution engine therein;
prompting the user to register a password and a hardware component with the computer system;
authorizing the user with access to a secure community of interest;
allowing the user to access the secure community of interest using the password and the hardware component; and
allowing, upon receiving the password and hardware component, the user to access read-only data within the secure community of interest such that access to the data is lost if the user removes the hardware component.

12. The method of claim 11, further comprising prompting the user to register a username with the computer system.

13. The method of claim 12, wherein the username is an email address, and a user must retrieve a hashed token from the email address to complete registration.

14. The method of claim 11, wherein the system requires a minimum password strength.

15. The method of claim 11, wherein the hardware component is a USB thumb drive, smartphone, or tablet computer.

16. The method of claim 11, wherein the user loses access to data within the secure community of interest after revocation of a user's authorization.

17. The method of claim 11, wherein access to the secure community of interest is restricted by geographic location.

18. The method of claim 11, further comprising encrypting data within a community of interest is encrypted and transmitting to an authorized user as such.

19. The method of claim 18, further comprising displaying a watermark each time data is decrypted.

20. The method of claim 11, further comprising updating a detailed event log of actions of registered users.

21. A computer-readable medium having computer-readable instructions stored thereon which, when executed by a computer system, cause the computer system to perform the steps of:
electronically communicating with a plurality of users over a network, the computer system storing a secure document distribution engine therein;
prompting the user to register a password and a hardware component with the computer system;
authorizing the user with access to a secure community of interest;
allowing the user to access the secure community of interest using the password and the hardware component; and
allowing, upon receiving the password and hardware component, the user to access read-only data within the secure community of interest such that access to the data is lost if the user removes the hardware component.

22. The computer-readable medium of claim 21, further comprising prompting the user to register a username with the computer system

23. The computer-readable medium of claim 22, wherein the username is an email address, and a user must retrieve a hashed token from the email address to complete registration.

24. The computer-readable medium of claim 21, wherein the system requires a minimum password strength.

25. The computer-readable medium of claim 21, wherein the hardware component is a USB thumb drive, smartphone, or tablet computer.

26. The computer-readable medium of claim 21, wherein the user loses access to data within the secure community of interest after revocation of a user's authorization.

27. The computer-readable medium of claim 21, wherein access to the secure community of interest is restricted by geographic location.

28. The computer-readable medium of claim 21, further comprising encrypting data within a community of interest is encrypted and transmitting to an authorized user as such.

29. The computer-readable medium of claim 28, further comprising displaying a watermark each time data is decrypted.

30. The computer-readable medium of claim 21, further comprising updating a detailed event log of actions of registered users.
